(19) United States
(12) Patent Application Publication
(10) Pub. No.: US 2003/0013472 A1
(43) Pub. Date: Jan. 16, 2003

(54) Communications networks

(76) Inventors: Gyorgy Miklos, Budapest (HU); Zoltan Turanyi, Budapest (HU); Andras Valko, Budapest (HU)

Correspondence Address: Stanley R. Moore, Esq., Jenkens and Gilchrist, P.C., 3200 Fountain Place, 1445 Ross Ave., Dallas, TX, 75202, US

(21) Appl. No.: 10/123,270

(22) Filed: Apr. 16, 2002

(30) Foreign Application Priority Data
Apr. 27, 2001 (GB) 0110396-9

(51) Int. Cl. H04B 7/00

(52) U.S. Cl. 455/517; 455/509

(57) ABSTRACT

In a wireless communications network connectivity information is communicated between nodes using beacon signals transmitted by the nodes of the network. A node scans for beacon signals, but does not engage in communication with another node in the network until data communication is required.

The present invention relates to communications networks.

### BACKGROUND OF THE INVENTION

Embodiments of the present invention are primarily concerned with short-range radio frequency communications protocols, such as that known as “Bluetooth” (™). In a system using the Bluetooth protocol, groups of nodes communicate on frequency-hopping channels defined in the Bluetooth specification 1.1 known as piconets. A piconet is a single communication channel, that has its frequency hopping sequence defined by the address and clock of the master node in the piconet. Embodiments of the present invention are concerned with the formation, maintenance and dismantling of such piconets.

The Bluetooth specification provides a solution to form, maintain and dismantle piconets. Piconet set up is based on the paging procedure described in the specification: a node in a paging state will become the master of the piconet, and a node in a page scanning state will become a slave in the piconet. All slave nodes have to use explicit signalling to negotiate with the master node when they are present in the piconet and when they leave the piconet or go to a power saving mode.

The solution in the existing specification solves the problem of piconet formation and maintenance, but it gives a solution that uses a relatively large overhead. Specifically, the paging procedure which may take several seconds must be used when a node joins a piconet. Since a slave node has to announce in advance when it is present in the piconet, it becomes very hard for a node to be a member in more than one piconet. This gives rise to difficulties with intra-and inter-piconet scheduling.

As described above and in the Bluetooth specification, nodes form so-called piconets which use respective frequency hopping sequences. Timing synchronisation is determined by the clock and address of the master node. A piconet has a single master node, and has one or more slave nodes. According to the Bluetooth specification a piconet can have up to seven active slave nodes.

According to the Bluetooth specification, a piconet uses a frequency hopping channel based on the master's clock and address. The channel hops to a new frequency in every timeslot, where the timeslot length is Tₛ=1/1600 sec.

To retain this synchronisation in a piconet, a master node is required to send packets that synchronise the slave nodes to the master node even if the master node is not sending data. All the slave nodes in a piconet must be within radio range of the master node so that every slave node can synchronise to the piconet using the master node's transmissions.

### SUMMARY OF THE PRESENT INVENTION

Embodiments of the present invention can provide procedures to form, maintain and tear down piconets, which is referred to here as a “lightweight piconet concept”.

According to the present invention, a node may join or leave a piconet without any signalling, i.e. there is no paging procedure. Instead, a node becomes part of a piconet by simply declaring itself to be a member and advertising it to its neighbours.

Piconet membership does not imply any commitments from a node. While it is expected that a node follows a single piconet frequency hopping sequence most of-the time, it is allowed for a node to leave this hopping sequence to communicate with a node outside the piconet on a different piconet frequency hopping sequence.

The lightweight piconet concept significantly reduces the overhead for a node joining a piconet and the signalling associated with temporarily leaving a piconet. However, there is no guarantee that a given node can be reached in a pre-determined amount of time. If a neighbouring node cannot be found in one piconet, its piconet membership has to be discovered once again.

When a node is master node of a piconet, then that piconet will be referred to as the master node's device piconet. This refers to the fact that the frequency hopping sequence of the piconet is defined by the node's clock and device address.

Note that although the present invention is described in terms of the Bluetooth technology, it is clearly applicable to other radio technologies as well, and specifically it may be applicable to other systems using frequency hopping radio technology

### DETAILED DESCRIPTION OF THE PREFERRED EMBODIMENTS

According to the lightweight piconet concept, nodes may temporarily or permanently join or leave the piconet on demand. The piconet whose hopping sequence is currently followed by a node is defined as its current piconet.

Besides the current piconet, another piconet is associated with each node; the so-called home piconet. The home piconet is where a node can be accessed by default; when it finishes its communication in its current piconet, it returns to its home piconet when the current piconet is different from its home piconet. It is assumed that most of the time a node follows the frequency hopping sequence of its home piconet, but there is no requirement on exactly when the nodes have-to follow the home piconet's hopping sequence. The lightweight piconet scheme allows nodes to temporarily leave the home piconet's frequency hopping sequence and communicate using another frequency hopping sequence (ie. another piconet) without any explicit signalling.

In such a scheme the following definition for the home piconet membership is used: a given piconet is the home piconet of a node when the node advertises it to be its home piconet. This means that each node can decide on its own which piconet to join as its home piconet, and there is no additional signalling procedure (specifically, no paging procedure) to select the home piconet, except that the node advertises its home piconet membership.

Home piconet membership advertisements can be sent in so-called beacon packets that all neighbouring nodes can receive. Other approaches are also possible, for example nodes may send piconet membership advertisements and scheduling information in upper-layer packets that are broadcast or multicast using regular data packets, though this approach might be less flexible than the beacon packet transmission method.

In addition, in some cases it is advantageous for each node to send an indication whether its own device piconet is available for other nodes as a home piconet. Specifically, a one-bit indication called WH (willing host) can be sent in beacon packets to signal whether the node accepts that other nodes choose the node as the master of their home piconet. This is advantageous in an application where not all nodes are ready to be masters of home piconets of other nodes. For example, a terminal might not be able to be a master of the home piconet of other nodes, whereas an access point may be able and willing to be a master of the home piconet of other nodes.

As stated earlier a node may leave its home piconet, which means that it will not be possible to determine in advance whether a given node is following the hopping sequence of its home piconet at a certain time instant. Not even the master is required to have a completely up-to-date list of the members of its piconet at a given time instant. However, a node can be contacted at its home piconet. Even if it leaves its home piconet temporarily, it has to return there after a certain (unspecified) amount of time.

The above definitions give a general framework of the lightweight piconet concept,-however they do not specify exactly how (i.e., on which piconet) data transmission takes place and how piconets are fomed. In the following a possible set of rules is given which define how piconets are formed. Specifically, it is necessary to determine the possible piconets from which a current piconet is to be selected, and how that current piconet should be selected. In addition, similar choice regarding the home piconet need to be determined.

The following description sets out several different scenarios for the choice of home and device piconets.

In a first embodiment, the home piconet of a node is always its own device piconet. In such a case, whenever a node is not busy communicating with a neighbour, it returns to the device piconet which uses the frequency hopping sequence defined by its own native clock and address. This is its home piconet where it can be contacted.

When node A wants to communicate with node B, then node A first tunes to B's home (and also device) piconet. It has to determine whether node B is also there and if both of them are present, they carry out the communication. If node B cannot be found, then the communication is retried later.

Data transmission is always carried out using the destination node's device (and also home) piconet.

The advantage of this approach is that it is a relatively simple and straightforward flat architecture. Its disadvantage is that when node A and B communicate, they have to switch to a new piconet each time the direction of the communication changes, and this can take a significant amount of overhead. Furthermore, when node B is communicating with a third node C, it can starve node A from transmitting to it and this cannot be well controlled or detected by A.

In a second embodiment, communication between the two nodes takes place on a well-defined piconet, and so no dynamic selection is needed.

Nodes are configured as either willing hosts or non-willing hosts. A willing host is a node that can be a master of the home piconet of other nodes. Non-willing hosts do not take this role. All nodes advertise their willingness in the WH field that is broadcast to neighbours.

In an access network scenario access points may act as willing hosts and terminals as non-willing hosts. Alternatively, in an office environment, a printer or a laptop may be a willing host, whereas a mouse or a keyboard is a non-willing host. In this case, the piconet selection for the data transmission is static; the home piconet of the destination is always chosen for data transmission.

The potential masters of the home piconet of a node are the neighbours which have their WH (willing host) bit set and have identical home and device piconets. In addition, the node's own device piconet is also a potential home piconet. (This is chosen as the initial home piconet when the node is initialised). If there is application-level information available about neighbours, only the nodes that run the suitable application are chosen. (For example, a terminal chooses only access points as the master of its home piconet, and never a printer or a refrigerator.) If there are several potential home piconet masters, a node may have several criteria by which it can select which to use. Some possible criteria are listed below:

Choose the one with which it has had the highest amount of data communication in a fixed time-window;

choose the one with the best radio link (if it can be measured);

Choose an arbitrary one and only choose a new one arbitrarily if the old master is no longer reachable;

Choose the one which can offer a certain quality of service (for example, choose the least loaded one) if the information is available (e.g., in the beacon packets).

Pre-assign the home piconet based on the application (for example, in the case of a laptop and its accessories such as the mouse and keyboard).

An alternative to the choice of source home piconet is always to choose the device piconet of the destination node for the data transmission. This has the advantage that it makes it possible to multiplex several data transmissions. At the same time, its disadvantage is that in this case nodes have to switch piconet more often away from their home piconet, which makes them harder to access.

Note that it is possible to implement static piconets selection with different rules.

In a third embodiment, dynamic selection of which piconet to use for a given data transfer is possible. This enables a node to choose the most appropriate piconet for its purposes.

In one possible implementation of the third embodiment, the choices of piconet for data transmission in the dynamic selection solution are the device piconet of the source node and the device piconet of the destination node. Negotiation to determine the piconet selection takes place on the home piconet of the destination node. However, the data transmission can go on a different frequency hopping sequence. The following algorithm is suggested to select the frequency hopping sequence for the data transmission.

Every node maintains a variable called Master Preference (MP). The variable can take values from 0 to MP-max. An example value of this parameter is 7. The meaning of this variable is as follows. MP signals the preference of a node to use its own device hopping sequence during data transmission. This information is transferred during the negotiation of piconet selection together with the WH (willing host) bit. The selection is as follows: if only one of the nodes has the WH bit set, then the frequency hopping sequence of that node is used. Otherwise the frequency hopping sequence of the node with the higher MP value is chosen. If two MP values are equal, then the frequency hopping sequence of the destination node is chosen.

There can be many possible alternatives for how to set the MP variable. In general, a node which communicates with many of its neighbours should be the master and have a higher MP but the exact procedure for setting this variable is not necessarily the same for all nodes. For example:

MP gives the number of other nodes with which the node has communicated (i.e. other than the one being addressed in the negotiation) in a given time-window MP_win.

MP gives the ratio of the time the node has spent communicating with another node in a given time-window MP_win

Any one of the above rules ensures that a node which communicates with many of its neighbours has a higher MP, and therefore its frequency hopping sequence is more likely to be selected for the data transmission.

The possible home piconet choices are the same as in the case of static piconet selection. Specifically, the potential master nodes of the home piconet are the neighbours which have their WH (willing host) bit set and have identical home and device piconets. In addition, the node's own device piconet serves as a potential home piconet. (This is chosen as the initial home piconet when the node is initialised.)

As described above, application-level information, if available, can be used to select the home piconet. If there are several potential home piconet master nodes, the node chooses the piconet where it has had the most traffic in a given time window. Alternatively, other selection criteria may be chosen, such as the ones described above.

Change of Home Piconet Status

When a node changes its home piconet, it becomes temporarily difficult for other nodes to initiate a data transfer to it because they initiate the data transfer on the old frequency hopping sequence if they do not know about the change of the home piconet. The new home piconet is advertised by the node (by sending beacon packets or by some other means), but it can take too long a time before the advertisements reach all of the neighbours.

The following procedures can make the switch in the home piconet more efficient.

The node begins to advertise its new home piconet earlier, before it actually makes the change. This is implemented in such a way that it advertises its current home piconet and its forthcoming home piconet simultaneously. Other nodes can try first the piconet that is believed to be the node's current home and then, if unsuccessful, can try the piconet advertised as the node's forthcoming home. This solution can make the piconet switch more efficient, but it is not very flexible since it requires the prediction of the home piconet switch and requires an additional field in the advertisements.

When the node switches its home piconet to a new one, it sends a special control packet that includes an advertisement in its payload. This packet can be sent to the master node, or as a broadcast packet. If the node communicated in its previous piconet with other nodes (not the ones that are the members of the piconet the node is about to join) then it may send such a control packet to the members of its old piconet as well. This is especially useful when the node knows that it is a master of a piconet with other nodes as slaves. Furthermore, such a packet may be sent to other neighbours in different piconets. In this way, all nodes that the node has recently communicated with can be notified about the home piconet switch. Even if this procedure is not completely reliable and does not reach all of the neighbours, it makes the home piconet switch significantly more efficient.

Alternatively, after the piconet switch, the home piconet advertisements can be sent more frequently. This can also be applied in combination with the other listed alternatives. This procedure also makes it quicker for the neighbours to be notified about the home piconet switch.

If a master of a node's home piconet switches its home piconet, it has an important negative side effect. Then the piconet itself is automatically disintegrated as soon as the nodes become aware of this fact, and the nodes have to find a new home piconet.

Slaves can become aware of the master's piconet change either by the master's explicit message (as described above), or by the fact that the home piconet advertisements from the master (typically in the form of beacons) no longer arrive. (But nodes must be careful since an advertisement might also have been lost or the advertisements can become less frequent.)

In this case, former slaves of the piconet revert back to a backup piconet as their home piconet. Unless otherwise signalled, this backup piconet is their own device piconet.

It is suggested that the piconet advertisements include the device clock and master address information about the backup piconet. By default, the backup piconet is the device piconet of the node, implying that the advertisements need to include the source address and clock of the node itself.

In this way, when the master goes away, every neighbour can immediately have an estimation about the new home piconet of the former slaves. This makes it possible for the nodes to communicate immediately using the backup piconet without having to wait for a new advertisement to re-discover the-home piconet memberships once again.

Example Applications

According to the lightweight piconet concept, nodes have considerable freedom in their behaviour. Nodes may decide what policy to use to select the frequency hopping sequence for a given data transfer, what algorithms to use to select their home piconet.

This suggests that the behaviour of a device can be controlled through configuration settings based on the application scenario. Some example applications are given below.

In the simplest case of a single-piconet application, e.g. a data transfer between a laptop and a palmtop, one of the nodes acts as the master and sends beacon packets with a rate that is sufficient to synchronise the clock of the devices. Nodes do not need to change piconets at all.

In the case of a large number of nodes scattered around a wide area, the lightweight piconet concept can be used to make it easier to connect the nodes and form an ad hoc network. In this case each device sends beacon packets allowing other nodes to discover it and update its home piconet membership status information. Nodes choose their home piconet based on the traffic so that they can stay in their home piconets most of the time. All nodes are allowed to communicate with all of their neighbours regardless of their piconet membership, but the nodes within the same home piconet can in general be accessed more easily.

In the case of an access network scenario, the lightweight piconet concept can be used both in access points that send beacon packets, and terminals that do not necessarily send beacon packets. In their beacon packets these access points could advertise their preference to be masters of their home piconets. Due to the lightweight piconet concept, handovers can be made seemless.

### CONCLUSION

In Bluetooth there is a significant overhead in setting up a piconet. Specifically, master nodes need to page the slave nodes. In contrast, embodiments of the present invention use a methodology with no overhead in setting up a piconet. Slave nodes become a piconet member simply by declaring themselves to be a member.

A Bluetooth master node has up-to-date knowledge about the state of the piconet members. The master node in the present invention does not need to have an up-to-date knowledge about the members of its piconet.

In Bluetooth, nodes have to use dedicated signalling methods to leave a piconet temporarily. According to the lightweight piconet concept, a node may choose to leave a piconet temporarily without any signalling.

1. A method of communicating connectivity information for a channel in a wireless communication system, the method comprising, in a node of the system:
transmitting a beacon signal which includes the connectivity information relating to the channel used by the node;
scanning for beacon signals from respective other nodes, and receiving such beacon signals; and
maintaining channel information on the basis of received beacon signals.

2. A method of maintaining connectivity information for a channel in a wireless communication system which has a plurality of frequency hopping channels, the method comprising, in a node of the network:
transmitting a beacon signal advertising a frequency hopping channel used by the node;
receiving beacon signals from respective other nodes which beacon signals advertise frequency hopping channels used by those nodes; and
maintaining connectivity information on the basis of received beacon signals.

3. A method as claimed in claim 1, wherein the information relating to the channel identifies the channel used by the node.

4. A method as claimed in claim 1, 2 or 3, wherein the node communicates with a destination node on a channel determined by the node.

5. A method as claimed in claim 1, 2 or 3, wherein the node communicates with a destination node on a channel determined by the destination node.

6. A method as claimed in any one of claims 1 to 5, wherein the communication system is a short range radio frequency communications system.

7. A method as claimed in claim 6, wherein the channel defines a piconet in the communications system.

8. A method of communicating connectivity information in a wireless communications system, the method comprising:
from a first node of the system, transmitting a first information signal containing data relating to a channel for use by the first node;
receiving, from a second node of the system at the first node of the system, a second information signal containing data relating to a channel for use by the second node;
maintaining channel information on the basis of received information signals.
